(19) United States
(12) Patent Application Publication
(10) Pub. No.: US 2026/0277599 A1
(43) Pub. Date: Sep. 17, 2026

(54) SYSTEMS AND METHODS FOR AUTOMATED AI-ASSISTED BACKPORTING OF SOFTWARE PATCHES

(71) Applicant: Cloud Linux Software Inc., Estero, FL (US)

(72) Inventors: Igor SELETSKIY, Palo Alto, CA (US); Nikita IVANOV, Yekaterinburg (RU)

(21) Appl. No.: 19/078,517

(22) Filed: Mar. 13, 2025

(51) Int. Cl. G06F 8/71

(52) U.S. Cl. CPC G06F 8/71

(57) ABSTRACT

A system detects, on a source code management system, a pull request from an upstream version of a software to one or more target versions of the software. When the pull request is detected, the system executes backporting by: collecting input parameters associated with the pull request from the source code management system, wherein the collected input parameters comprise a patch; and for each target version of the software: the system analyzes the input parameters using a first machine learning model (MLM) to determine whether the target version is affected by the patch, generates, by a second MLM, an adapted patch that adapts the patch to a source code of the target version, wherein the first MLM indicates that the target version is affected by the patch; and applies the adapted patch on the target version via the source code management system.

### FIELD OF TECHNOLOGY

The present disclosure relates to the field of software development and maintenance, and, more specifically, to systems and methods for backporting software patches across multiple software versions.

### BACKGROUND

In software projects, especially open-source projects, multiple versions of a project are often maintained to meet various user needs. Security patches (or bug fixes) must be consistently applied across various versions of software to address emerging security vulnerabilities. To accomplish this, a process of backporting of patches is used to take a software patch or update that has been developed for a newer version of software and apply it to an older version. This is often done to address security vulnerabilities, bugs, or other issues in the older version without requiring a full upgrade to the latest version. However, backporting patches is a manual, error-prone, and time-consuming process, that poses challenges in efficiency and management of security of the software project.

Existing solutions, such as rule-based tools or semi-automated approaches (e.g., Miss Islington for Python), handle only specific parts of the process and require manual intervention when conflicts arise. For example, Miss Islington automates pull requests, but requires conflict resolution to be handled manually. Another approach, e.g., using FixMorph, needs a kernel-specific rule-based system.

Therefore, there is a need for an automated method for backporting such that manual efforts are reduced in adapting patches across different types of software and/or versions of software. Moreover, there is a need to improve the accuracy and the speed of backporting.

### SUMMARY

Aspects of the present disclosure describe systems and methods for providing an artificial intelligence (AI) powered service for automating backporting of patches from a given upstream version of software to a target version of the software. The method of the present disclosure leverages AI to adapt patches, handle conflicts, and improve patch quality over time through an iterative feedback loop-thereby addressing the shortcomings of conventional systems described previously. The AI-powered service to automate the backporting reduces manual efforts, and improves the speed and accuracy of the backporting. The AI-driven conflict resolution and iterative feedback loop allow patches to be continuously refined without developer intervention. As such, software maintenance can be extended with reduced manual effort. Additionally, the platform-agnostic nature of the system of the present disclosure makes it suitable for use across multiple environments and version platforms for controlling the network and for providing security to the network.

In an exemplary aspect, the techniques described herein relate to a method for automated backporting of patches using machine learning, the method including: detecting, on a source code management system, a pull request from an upstream version of a software to one or more target versions of the software; and when the pull request is detected, executing backporting by: collecting input parameters associated with the pull request from the source code management system, wherein the collected input parameters include a patch; and for each target version of the software: analyzing the input parameters using a first machine learning model (MLM) to determine whether the target version is affected by the patch; generating, by a second MLM, an adapted patch that adapts the patch to a source code of the target version, wherein the first MLM indicates that the target version is affected by the patch; and applying the adapted patch on the target version via the source code management system.

In some aspects, the techniques described herein relate to a method, further including: returning, on a user interface, a status indicating that the target version is not affected by the patch when the target version is not affected by the patch.

In some aspects, the techniques described herein relate to a method, further including: storing and/or sending data for updating datasets used for training the first MLM and/or the second MLM, wherein the first MLM and the second MLM are provided by an artificial intelligence (AI)-powered web service.

In some aspects, the techniques described herein relate to a method, further including: testing the adapted patch for errors; and when the testing of the adapted patch indicates an error in backporting: updating a number of attempts for adaptation of the patch; adjusting or re-generating the adapted patch until either the adapted patch is successfully backported, or the number of attempts reaches a predetermined threshold; and reporting, on a user interface, a failure when the predetermined threshold is reached without successful backporting of the patch.

In some aspects, the techniques described herein relate to a method, wherein the collected input parameters further include a source code of the patch received from upstream, and source codes of any number of target versions.

In some aspects, the techniques described herein relate to a method, further including initiating the backporting in response to determining that the pull request is associated with a security fix.

In some aspects, the techniques described herein relate to a method, further including: applying automated testing and feedback for backporting of the patch by: receiving a report of a failure of a backporting of the patch; activating a pull request refinement process for the reported failure of the backporting of the patch; providing to an AI-powered web service, test results, previous inputs, configuration details for the refinement, and information related to branches and versions that are affected by the refinement; and performing patch refinement based on the test results and returning an updated patch to the source code management system.

In some aspects, the techniques described herein relate to a method, wherein events that trigger the backporting are customizable to be initiated based on user-defined conditions.

In some aspects, the techniques described herein relate to a method, wherein users selectively configure which branches should receive backports of patches when the pull request is detected.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for automated backporting of patches using machine learning, including: at least one memory; and at least one hardware processor coupled with the at least one memory and configured, individually or in combination, to: detect, on a source code management system, a pull request from an upstream version of a software to one or more target versions of the software; and when the pull request is detected, execute backporting by: collecting input parameters associated with the pull request from the source code management system, wherein the collected input parameters include a patch; and for each target version of the software: analyze the input parameters using a first machine learning model (MLM) to determine whether the target version is affected by the patch; generate, by a second MLM, an adapted patch that adapts the patch to a source code of the target version, wherein the first MLM indicates that the target version is affected by the patch; and apply the adapted patch on the target version via the source code management system.

In some aspects, the techniques described herein relate to a non-transitory computer readable medium storing thereon computer executable instructions for automated backporting of patches using machine learning, including instructions for: detecting, on a source code management system, a pull request from an upstream version of a software to one or more target versions of the software; and when the pull request is detected, executing backporting by: collecting input parameters associated with the pull request from the source code management system, wherein the collected input parameters include a patch; and for each target version of the software: analyzing the input parameters using a first MLM to determine whether the target version is affected by the patch; generating, by a second MLM, an adapted patch that adapts the patch to a source code of the target version, wherein the first MLM indicates that the target version is affected by the patch; and applying the adapted patch on the target version via the source code management system.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an architecture of a system for providing an AI-powered service for automating backporting of patches from a given upstream version of software to a target version of the software.

FIG. 2 illustrates an example implementation of the module for providing the automated backporting of the patches in accordance with aspects of the present disclosure.

FIG. 3 is a block diagram illustrating a system for training the AI processing module to automate backporting of patches according to aspects of the present disclosure.

FIG. 4 illustrates a flow diagram of a method for providing an AI-powered service for automating backporting of patches from a given upstream version of software to a target version of the software in accordance with aspects of the present disclosure.

FIG. 5 illustrates an example automated testing and feedback enhancement for providing the automated backporting of the patches that incorporates in accordance with aspects of the present disclosure.

FIG. 6 illustrates a flow diagram of a method for automated testing and feedback for backporting of patches from an upstream version of software to a target version of the software in accordance with aspects of the present disclosure.

FIG. 7 illustrates a flow diagram of a method for automated backporting of patches using machine learning in accordance with aspects of the present disclosure.

FIG. 8 presents an example of a general-purpose computer system on which aspects of the present disclosure can be implemented.

### DETAILED DESCRIPTION

Exemplary aspects are described herein in the context of a system, method, and computer program product providing an AI-powered service for automating backporting of patches from a given upstream version of software to a target version of the software. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

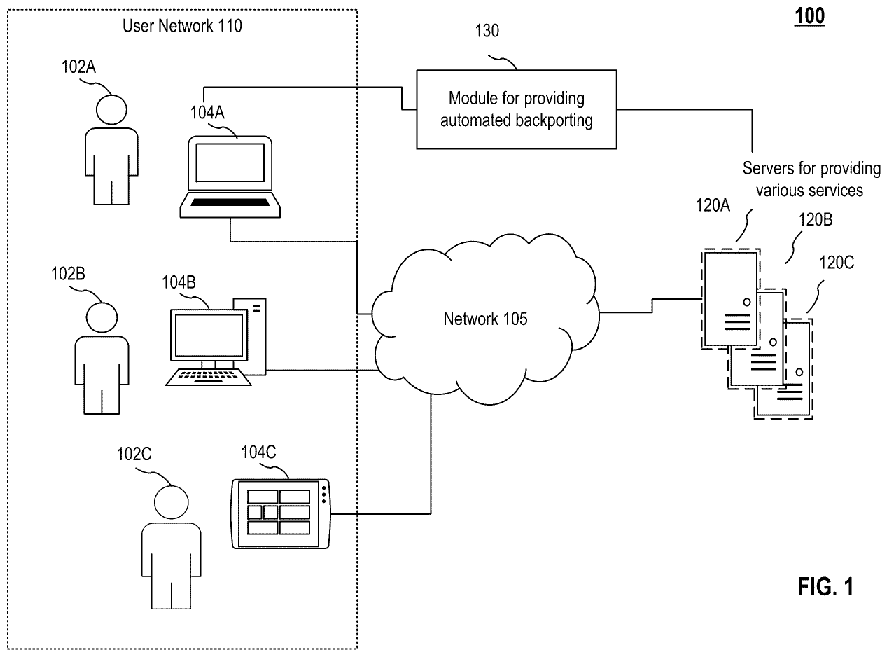

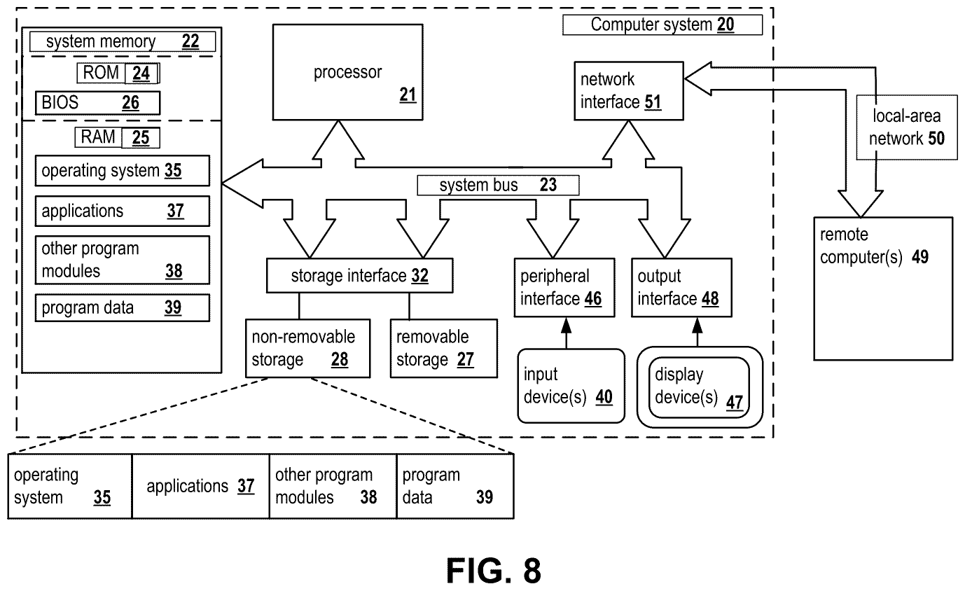

FIG. 1 illustrates an architecture of a system 100 for providing an AI-powered service for automating backporting of patches. The system 100 includes user devices 104A, 104B, and 104C, servers 120A, 120B, and 120C communicating via a network 105 (e.g., the Internet) in accordance with aspects of the present disclosure. The individual hardware structure of these user devices and servers may correspond to computer system 20 in FIG. 8. Users 102A, 102B, and 102C may access various services via user devices 104A, 104B, and 104C, including the functionality provided by module 130.

Module 130 enables automated backporting of patches using machine learning and may be executed by one or more devices (e.g., user devices 104A and server 120A) in system 100. For example, module 130 may be split into a thin client application executed on user device 104A and a thick client application executed on server 120A. A thin client application performs actions that do not require substantive computational resources whereas a thick client application performs processor-heavy actions. A user may interact with a source code management system, request backporting, review patches, etc., using the thin client application of module 130 installed on user device 104A. Processor-heavy tasks such as adapting patches, implementing backporting, and/or executing/training machine learning models may be performed using the thick client application of module 130 on one or more servers (e.g., server 120A, 120B).

In some aspects, user devices 104A, 104B, and 104C may be part of a user network 110 (e.g., the network within an institution such as a university, hospital, company, etc.). When a security vulnerability is identified, a patch may be generated for the newest version of the software. However, user network 110 may contain any number of devices that cannot have the newest versions of the software downloaded. Thus, simply downloading the newest version of software is not always suitable, e.g., backward compatibility with other software and hardware, processor capabilities, etc., may limit the options available for each device. As such, there is a need to address the vulnerability across various versions of the software deployed throughout user network 110. As described above, the patch for addressing the vulnerability is typically released in the newest version of the software. If the older versions are affected by the vulnerability, the patch needs to be adapted to be applicable and compatible with the older version of the software. If the older versions of the software are not affected by the vulnerability, the patch does not have to be applied to the older versions of the software. The present disclosure provides an AI-based approach for automating this backporting process such that patches are applied efficiently.

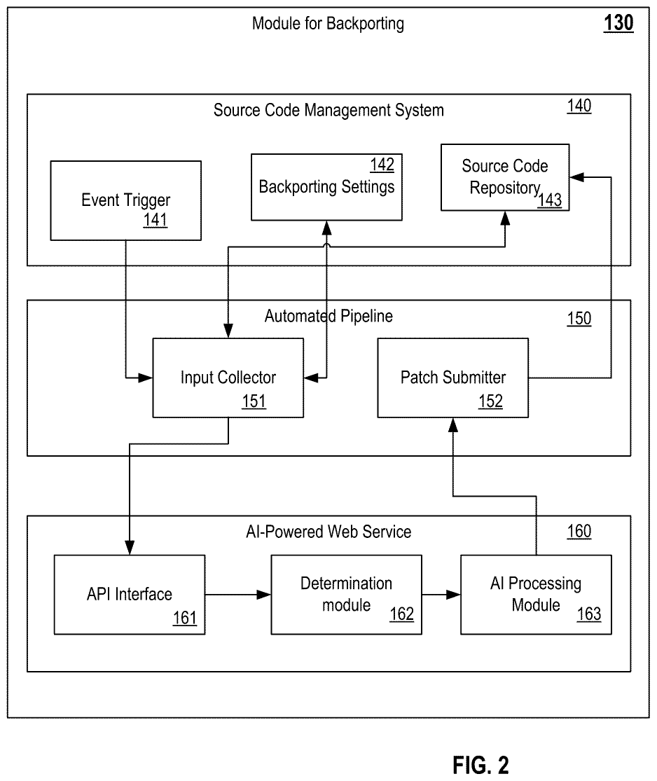

FIG. 2 illustrates an example implementation of the module 130 for providing the automated backporting of the patches in accordance with aspects of the present disclosure. The module 130 includes at least: a source code management system 140, an automated pipeline 150, and an AI-powered web service 160.

The source code management system 140 includes at least: an event trigger 141, backporting settings 142, and a source code repository 143. The source code management system 140 is used for activating the backporting process when an event is triggered. The event is triggered, for instance, when a Pull Request (PR) is detected. For example, the PR may be detected when a patch is released for a security fix. The backporting settings 142 contain configuration settings for backporting, such as specifications describing which versions of the software require a security patch, specifications of branches of the software architecture requiring the patch, etc. The source code repository 143 includes necessary code information to adapt the patch based on the backporting settings.

The automated pipeline 150 includes an input collector 151 and a patch submitter 152. The automated pipeline 150 is used for: collecting input from upstream (i.e., from the source code management system 140), processing data (e.g., event triggers, backporting settings, source codes), submitting patches to be adapted to the AI-powered web service 160 via the API interface 161, receiving statuses and/or patches from the AI-powered web service 160, and submitting the adapted patches to the source code management system for application. The adapted patches are stored in the source code repository 143.

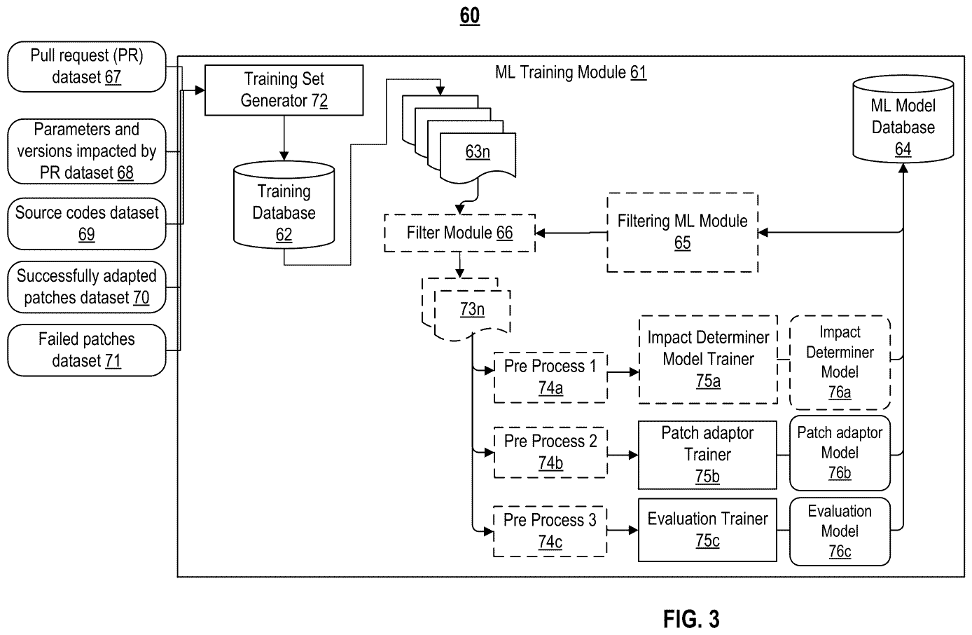

The AI-powered web service 160 includes an API interface 161 that serves as the entry point for data and requests from the automated pipeline 150, forwarding inputs to the determination module 161, a determination module 162 (e.g., a first machine learning model) that is used to analyze and determine whether the patch affects the various versions of software, e.g., whether or not the vulnerability associated with the security fix is applicable for specific versions of the software, and an AI processing module 163 (e.g., a second machine learning model). The determination module 162 determines the applicability of the patch across other versions of software and/or branches of a software architectures. The AI processing module 163 is used to adapt the patch for different target versions of the software based on the analysis, ensuring compatibility and meeting security requirements across the network. The training of the AI processing module 163 is further described below in conjunction with FIG. 3.

In operation, when a security fix is submitted in a newer software version or any other configured action is detected, a Pull Request (PR) is submitted to the source code management system 140 (e.g., Github, Gitlab, etc.). The PR is marked as a security fix or a configuration change, as appropriate. The source code management system 140 triggers the automated pipeline 150 for backporting the fixes to any number of older versions of the software. The automated pipeline 150 initiates the backporting via an input collector 151. The initiation of the backporting includes: collecting input parameters from the source code management system 140, and passing the collected input parameters to the AI-powered web service 160 via an API interface 161. In one aspect, the input parameters include at least the patch received from upstream (i.e., the patch received when the event is triggered for the newer software), a source code of the upstream version (i.e., a source code of the newer software), and a source code of the target version (i.e., the source code of the older version of the software to which the patch is to be backported). The AI-powered web service 160 receives the input parameters from the automated pipeline 150. Then, a determination module 162 of the AI-powered web service 160 analyzes the input parameters to determine whether the target version is affected by the vulnerability addressed by the patch. When the target version is not affected, the determination module 162 returns a status indicating that the target version is not affected by the patch. When the target version is affected, the patch is forwarded to an AI processing module 163. The AI processing module 163 adapts the patch received from upstream to the source code of the target version, and resolves conflicts and structural differences. Then, the AI processing module 163 returns the adapted patch to the automated pipeline 150. The patch submitter 152 submits the adapted patch to the source code repository 143 of the source code management system 140.

In order to perform the backporting, the AI processing module 163 is trained to have the following key capabilities and/or features:
1) Features for AI-powered patch adaptation;
2) Features for vulnerability impact analysis;
3) Features for providing iterative feedback to improve the patch adaptation;
4) Features for making the backporting process platform-agnostic; and
5) Features for handling errors.

In order to provide the features for the AI-powered patch adaptation, the system 100 uses AI to adapt patches between different software versions, including resolving structural differences and conflicts. The system is designed to handle both single-commit and multi-commit patches. For patches involving multiple commits, the AI-powered web service processes the multi-commit patches as a sequence and adapts them collectively to ensure compatibility. If the patch does not apply cleanly to the target version, the system uses AI to resolve conflicts and adjust the patch accordingly.

For features used for vulnerability impact analysis, AI-powered web service analyzes both the source code of the upstream patch and the source code of the target version to determine if the target version is affected by the vulnerability. If the vulnerability is not present, the system returns a status indicating that no backporting is required-thereby helping developers focus only on the versions that genuinely need patching.

For features used to provide iterative feedback to improve the patch adaptation, the system first determines if a patch fails during automated testing. For example, after a patch is adapted for a given target code, the adapted code is tested by invoking a test via the event trigger. If the test fails, the source code management system adjusts and resubmits the patch to the AI powered web service for adaptation of the modified patch. The process is repeated until either the adapted patch is successful in passing the test or a retry limit is reached.

For features used to make the backporting process platform-agnostic, the automated pipeline 150 is designed to be flexible in that it is capable of integrating with various version control platforms (e.g., GitHub, GitLab, Bitbucket). For instance, the user may configure specific pipeline triggers based on their workflow, such as commit messages or tags, ensuring seamless integration into diverse environments.

For features used to handle errors, the system returns detailed error messages when issues arise during the backporting process. The error messages may then be used to troubleshoot and make the necessary changes for a next patch. When errors are addressed, the feedback is provided to the system-thereby improving the algorithm overtime.

In order to provide the above capabilities, the AI processing module 163 includes one or more trained machine learning models (MLMs), such as, a large language model (LLM). An LLM is an advanced AI system designed to understand and generate human-like text. For example, an LLM of AI processing module 163 may receive an initial version of a patch for a latest version of a software and may be queried to generate an adapted patch for backporting to a prior/different version of the software.

LLM models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (which may include training, retraining, distillation, fine-tuning, etc.) to teach each LLM model to perform their respective specific tasks. As a non-limiting example, the LLM models may incorporate one of the machine learning models listed below.

Typically, a LLM comprises a deep neural network that has a transformer architecture. Neural networks are a class of machine learning models inspired by the structure and functioning of the human brain. They consist of interconnected nodes, called neurons, or artificial neurons, organized into layers. Neural networks are capable of learning complex patterns and representations from data. A transformer-based neural network has an encoder/decoder structure with numerous stacked multi-head attention layers and feed forward network layers (e.g., neural networks). This architecture allows the model to process and generate text effectively, capturing long-range dependencies and contextual information. Transformers are well-suited for tasks like natural language processing and image classification and generation. Common examples of transformer models are generative pre-trained transformers (GPTs) and Bidirectional Encoder Representations from Transformers (BERTs).

In other aspects, the AI processing module 163 may include other types of MLMs such as: convolution neural networks (CNNs), recurrent neural networks (RNNs), long short-term memory (LSTM) networks, gated recurrent unit (GRU) networks, autoencoders, and generative adversarial networks (GANs). Each of these neural networks employ different types of learning (such as supervise or unsupervised learning), have different architectures, and various applications, such as NLP, image recognition, image generation, speech recognition, video processing, language translation, etc.

A CNN is specialized for processing grid-like data, such as images, and employs convolutional layers to learn spatial hierarchies of features, reducing the need for manual feature engineering. CNNs are well-suited for tasks like image classification, object detection, and image generation. An RNN is designed for sequential data, where the order of inputs matters. An RNN includes loops in the network architecture to allow information to persist, and is useful for tasks like natural language processing, speech recognition, and time-series prediction. An LSTM network is an extension of an RNN designed to overcome the vanishing gradient problem. LSTMs have memory cells that can store and retrieve information over long sequences, making them effective for capturing long-term dependencies in sequential data. A GRU network is similar to LSTMs and is another type of RNN with mechanisms to address the vanishing gradient problem. GRUs have a simpler architecture with fewer parameters compared to LSTMs. An autoencoder is a type of neural network used for unsupervised learning and dimensionality reduction, and consists of an encoder that compresses input data into a lower-dimensional representation (encoding) and a decoder that reconstructs the original input from the encoding. A GAN comprises a generator and a discriminator trained simultaneously through adversarial training. The generator aims to generate realistic data, while the discriminator tries to distinguish between real and generated data. A GAN is widely used for image and content generation tasks.

FIG. 3 is a block diagram illustrating a system for training the AI processing module 163 to automate backporting of patches according to aspects of the present disclosure. As shown in example 60, a ML training module 61 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained data sets, the specialized machine learning models may perform particular tasks such as analyze source codes to determine whether or not backporting is needed for a particular version of software, adapt the patch to particular source codes when the backporting is needed, perform tests to determine whether the adapted patch passes tests for implementation, fine-tuning the adapted patch when fine-tuning is necessary, and the like. Each of these steps can be automated to automate the process of backporting and reduce errors. To facilitate the training, a large amount of data is used, with decisions that are successful and unsuccessful appropriately chunked to enable the algorithm to iteratively get better. For example, to teach the algorithm to predict when the backporting is needed, datasets are subdivided and provided to the system to learn from the outcomes. Similarly, codes are iteratively adjusted and provided to the training algorithm. If a developer ends us adjusting the code to adapt the patch, the resulting fine-tuned patch is provided to the trainer.

Supervised learning is effective for tasks such as classification (assigning inputs to predefined categories) and regression (predicting continuous values) since it relies on the availability of labeled data for both training and evaluation phases. In supervised learning, the ML training module 61 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 61 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 61 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 61 includes at least a training database 62 configured to store the raw training data 63n and corresponding labels, a ML model database 64 to store the trained models (e.g., models 76a, 76b, 76c). In some aspects, the ML training module 61 may include a filtering machine learning model 65 and a filter module 66 configured to filter data from the training database 62 for training by removing poorly generated training data.

For instance, the training data may include: dataset 67 for pull requests, dataset 68 for parameters and versions impacted by pull request, dataset 69 a list of source codes or target versions of software impacted by pull request, dataset 70 for successfully adapted patches, and dataset 71 for unsuccessful patch adaptations, etc.

An optional filter module 66 is configured to filter out bad training data in order to clean up the training data in the training dataset 63n. In some examples, the filter module 66 may be a neural network. In some examples, the filter module 66 is a mathematical model. In some examples, the cleaned training dataset 73n then undergoes optional preprocessing steps depending on which neural network or model is being trained.

The optional preprocess 1 74a, preprocess 2 74b, and preprocess 3 74c are automated processes that modify the raw data received from 63n (or cleaned training dataset 73 n) and prepare the raw data as input to the respective model trainers (e.g., impact determiner model trainer 75a which is used for determination of which versions of software are impacted by patch, a patch adaptor model trainer 75b, and an evaluation model trainer). These may be described in the machine learning training module 61 as snippets of code that prepares the datasets. In some examples, the preprocessing module (e.g., preprocess 1 74a, preprocess 2 74b, and preprocess 3 74c) for a particular trainer may be an automated script or code that will be setup the first time any model is trained.

The impact determiner trainer 75a, patch adaptor model trainer 75b, and evaluation model trainer 75c are the scripts or code that train the model. The impact determiner trainer 75a, patch adaptor model trainer 75b, and evaluation model trainer 75c may be a script or code that holds the instructions on how a model should be trained (e.g., optimization method, model architecture, dataset division, etc.) and also runs the training. The impact determiner trainer 75a, patch adaptor model trainer 75b, and evaluation model trainer 75c each take as input the raw or filtered processed training data and train impact determiner model 76a, patch adaptor model 76b, and evaluation model 76c to achieve their specific objectives, respectively.

In summary, the raw dataset 63n or cleaned dataset 73n may optionally go through different preprocessing steps 74a, 74b, and 74c and then a corresponding impact determiner trainer 75a, patch adaptor model trainer 75b, and evaluation model trainer 75c to generate a trained impact determiner model 76a, a trained patch adaptor model 76b, and a trained evaluation model 76c. In some examples, each of these models may be a neural network.

As a non-limiting example, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 63n used for training may include noise and bad training data from the training database 62. Accordingly, to create a clean and filtered training dataset, the filter module 66 is configured to filter out unwanted data points from the raw training dataset 63n by developing smaller, less accurate systems based on patterns and metadata information.

During the training process, impact determiner trainer 75a, patch adaptor model trainer 75b, and evaluation model trainer 75c (e.g., neural networks) are presented with input data and labels of actual values, and the optimization objective, which aims to minimize the difference between the actual value and the predicted value, is calculated. The optimization algorithm updates the parameters of impact determiner trainer 75a, patch adaptor model trainer 75b, and evaluation model trainer 75c to reduce the value of the objective. This process is repeated for several iterations until the parameters do not change anymore. This process is repeated for various combinations of hyperparameters, and the model with the smallest label prediction error is selected as the final model.

When a new model (e.g., a trained impact determiner model 76a, a trained patch adaptor model 76b, and a trained evaluation model 76c) is created, and a new process for filtering and automated labeling is established, it is added to the ML model database 64 in the ML training module 61. This enables the new model to be part of the closed-loop model update process. Optionally, at regular intervals, data which is continuously collected can be filtered, labeled, and used to update old models by an optional filtering machine learning module 65. In some examples, the filtering machine learning module 65 is a neural network. In some examples, the filtering machine learning module 65 is a mathematical model. This approach may capture changes in the data over time.

In one aspect, a MLM trainer module 61 may be used to prepare an untrained MLM or to fine-tune a trained MLM utilized in the AI processing module 163. To that end, a MLM may be trained or fine-tuned using a training dataset to “learn” how to backport patches from one version of software to another version of software. As an example, the training dataset may include at least: backported patches (e.g., software codes) during preparing (which may include training, retraining, distillation, fine-tuning, etc.), the training dataset are input into the MLM. The results from the MLM are then compared with known dataset results using the corresponding labels identifying successful backporting as well as failed attempts at backporting.

For every input training sample from the training dataset, the MLM will produce a prediction consisting of values representing a probability that patches are correctly divided into patches that have impact on specific versions of software, patches that have no impact on other versions of software, patches that were successfully adapted to target versions, patches that had errors in being adapted to target versions, and so on. The trained MLM then uses a loss function that quantifies the error between the predicted output and the ground truth for a given training sample. In other words, the loss function can be used to guide the learning process by updating the neural network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the LLM is trained, the trained MLM may be used for inference, e.g., to properly predict which versions of software are impacted by a given vulnerability and/or related patch, which adaptation of software is needed for backporting, etc. During inference, the trained MLM does not re-evaluate or adjust the layers of the neural network based on the results. Instead, the inference applies knowledge from the trained neural network and uses it to infer a result (e.g., provide an adapted patch). Accordingly, when a new unknown dataset (e.g., new learning materials) is input through the trained neural network, the trained MLM outputs a prediction of an accuracy of an adapted patch based on predictive accuracy of the MLM.

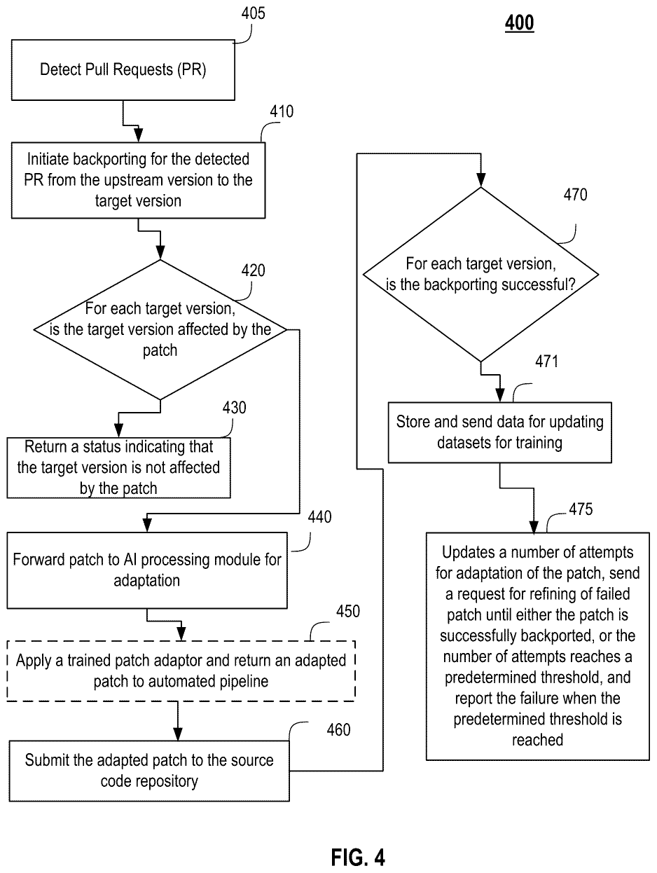

FIG. 4 illustrates a flow diagram of a method 400 for providing an AI-powered service for automating backporting of patches from an upstream version of software to a target version of the software in accordance with aspects of the present disclosure.

In step 405, method 400 detects a Pull Request (PR), for instance, a PR marked as a security fix or a configuration change is detected by a source code management system 140 (e.g., Github, Gitlab, etc.).

In step 410, method 400 initiates backporting for the detected PR from the upstream version to the target version, wherein the initiation of the backporting comprises collecting input parameters from a source code management system and passing the collected input parameters to an AI-powered web service. For example, the source code management system 140 triggers the automated pipeline 150 for backporting fixes to any number of older versions of the software, herein referred to as target versions of software.

In one aspect, the collected input parameters include at least the patch received from upstream (i.e., the patch received when the event is triggered for the newer software), a source code of the patch received from upstream (i.e., a source code of the newer software), and source codes of any number of target versions (i.e., the source codes of the older versions of the software to which the patch is to be backported).

In step 420, for each target version, method 400 receives the input parameters, applies the trained impact determiner model 76a to analyze the input parameters, and determines whether the target version is affected by the patch (i.e., by the vulnerability addressed by the patch). For example, a determination module 162 of the AI-powered web service 160 receives the input parameters from the automated pipeline 150 and processes the data to determine whether the backporting is needed for each target version. When the target version is not affected by the patch, the method proceeds to step 430. When the target version is affected by the patch, the method proceeds to step 440.

In step 430, via the determination module 162, method 400 returns a status indicating that the target version is not affected by the patch.

In step 440, via the determination module 162, method 400 forwards the patch to an AI processing module for adaptation of the patch received from upstream to the source code of the target version. The adaptation of the patch includes resolving conflicts and structural differences between the version received from upstream and the target version.

In step 450, by the AI processing module 163, method 400 processes the patch by applying the trained patch adaptor model 76b, and returns an adapted patch to the automated pipeline 150.

In step 460, method 400 submits the adapted patch to the source code repository 143 of the source code management system 140 via the patch submitter 152.

In step 470, for each target version, method 400 determines whether or not the backporting was successful. For example, method 400 applies the trained evaluation model 76c to determine whether or not the patches were successfully adapted and implemented. When the backporting is successful, method 400 proceeds to step 471. Otherwise, method 400 proceeds to step 475.

In step 471, method 400 stores and/or sends data for updating datasets used for training, and ends the backporting.

In step 475, method 400 updates a number of attempts for adaptation of the patch; sends a request to the AI processing module requesting for refining or readaptation of the failed patch until either the patch is successfully backported, or the number of attempts reaches a predetermined threshold; and reports the failure when the predetermined threshold is reached without successful backporting of the patch.

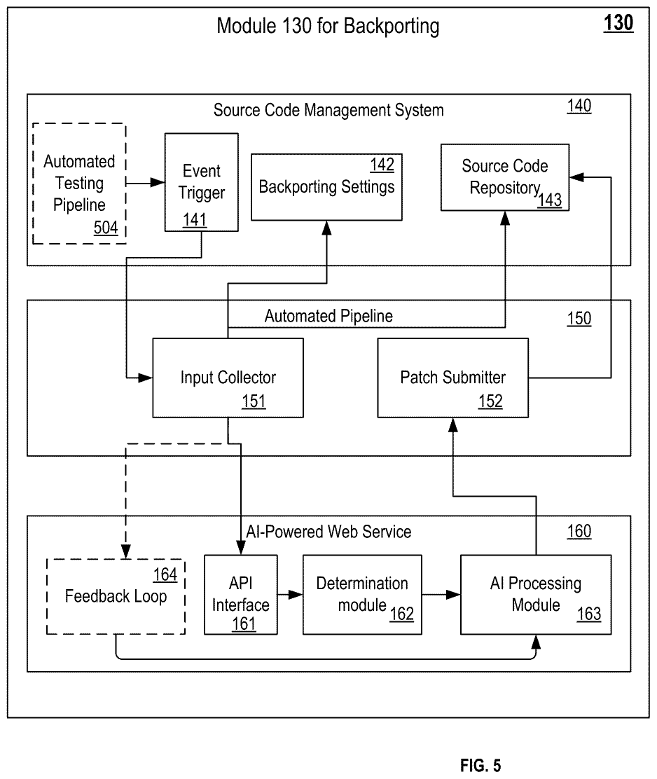

FIG. 5 illustrates an example automated testing and feedback enhancement 500 for providing the automated backporting of the patches that incorporates in accordance with aspects of the present disclosure. The enhancement adds automated testing and feedback loop-thereby enhancing patch accuracy and quality through iterative refinement based on test results. When the enhancement is included, the source code management system 140 further include an automated testing pipeline 504 for Continuous Integration (CI) and Continuous Delivery (CD), and the AI-powered web service 160 includes a feedback module 164 that determines the applicability of the patch across other versions of software and/or branches of a software architectures. When a patch fails to be backported, the automated testing pipeline 504 reports the failure thereby initiating the refinement process. The event trigger 141 activates the PR refinement upon receiving the reporting of the failure. The input collector 151 of the automated pipeline passes test results and previous inputs to the AI-powered web service, configuration details for the patch refinement, including branches and versions that are affected by the refinement to the AI-powered web service 160 via the API interface 161. The feedback module 164 of the AI-powered web service 160 requests the AI processing module 163 to perform the patch refinement based on the test results. The AI processing module 163 readapts the patch based on the test results, and returned an updated patch—ensuring compatibility with effectiveness across the various versions. Then, the output of the AI processing module 163 is submitted to the patch submitter 152 which forwards the readapted patch to the source code management system 140 for testing and deployment. When the source code repository 143 receives the refined patch, the source code repository updates the PR with the refined patch and ensures correct application.

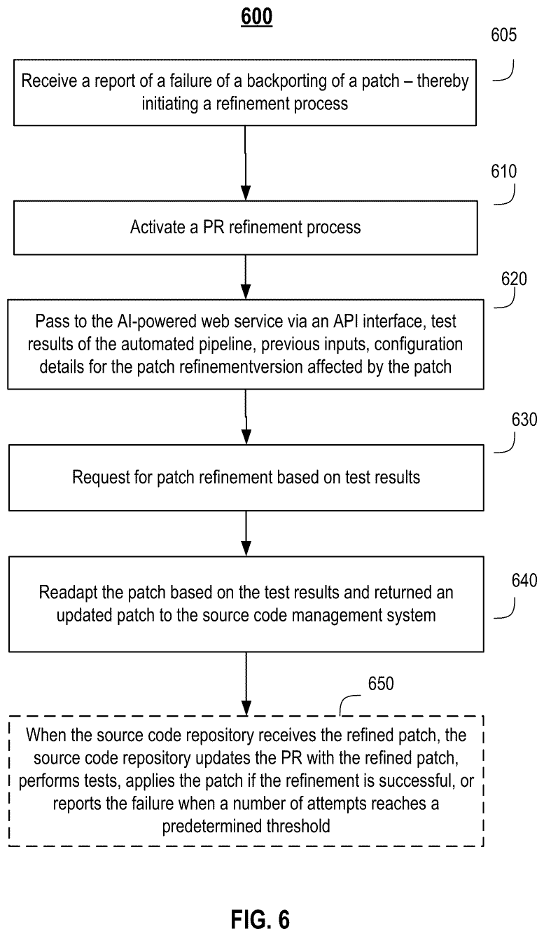

FIG. 6 illustrates a flow diagram of a method 600 for automated testing and feedback for backporting of patches from an upstream version of software to a target version of the software in accordance with aspects of the present disclosure.

In step 605, method 600 receives a report of a failure of a backporting of a patch thereby initiating a refinement process.

In step 610, via the event trigger 141, method 600 activates a PR refinement process.

In step 620, via input collector 151, method 600 passes to the AI-powered web service via an API interface, test results of the automated pipeline, previous inputs, configuration details for the patch refinement, including branches and versions that are affected by the refinement.

In step 630, via a feedback module 164 of the AI-powered web service 160, method 600 requests the AI processing module 163 to perform the patch refinement based on the test results.

In step 640, by the AI processing module 163, method 600 readapts the patch based on the test results and returned an updated patch to the source code management system through the patch submitter 152.

In step 650, when the source code repository 143 receives the refined patch, the source code repository updates the PR with the refined patch, performs tests, applies the patch if the refinement is successful, or reports the failure when a number of attempts reaches a predetermined threshold.

Thus, using the steps of methods 400 and 600, the system of the present disclosure improves the process of backporting by first determining if the target version is affected by the vulnerability addressed by the upstream patch. If no backport is necessary, the system communicates the status. The combined flowchart when the enhancement (feedback) is provided includes: (1) Patch triggering based on predefined actions; (2) AI-powered patch adaptation; (3) automated testing; (4) iterative feedback loop to refine failed patches; (5) final application of successful patches.

In one aspect, the trigger mechanism is customizable to be initiated based on user-defined conditions. In addition, the patches are adapted using AI-powered web service which is capable of resolving complex version conflicts. The method of the present disclosure also automates the management of the application of the patches, the testing, feedback processing. The feedback loop-iteratively adjusts patches based on automated test outcomes-reducing error handling and providing detailed error messages to aid troubleshooting.

In one aspect, the system of the present disclosure allows developers and network maintenance staff to selectively configure which branches should receive backports. This enables targeted application of security patches or bug fixes across specific branches, such as applying patches to versions like [‘3.9’, ‘3.10’, ‘3.11’], when the corresponding commit is detected. branches should receive backports selectively. This enables targeted application of security patches or bug fixes across specific branches, such as applying patches to versions like [‘3.9’, ‘3.10’, ‘3.11’], when the corresponding commit is detected.

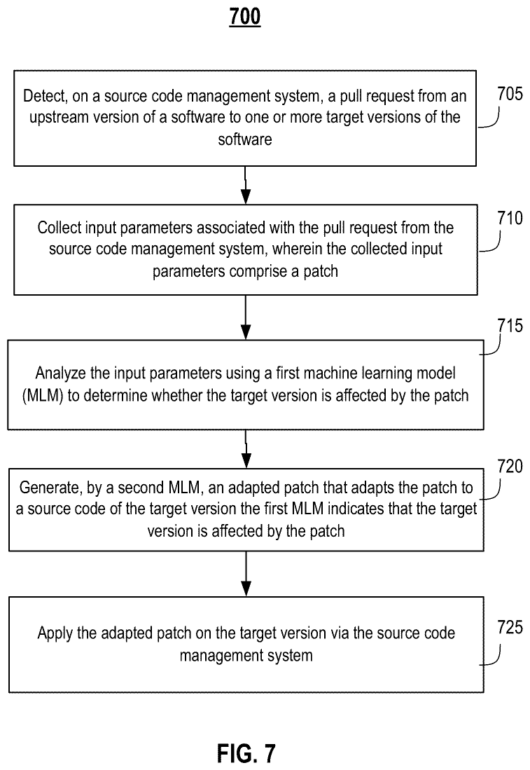

FIG. 7 illustrates a flow diagram of method 700 for automated backporting of patches using machine learning in accordance with aspects of the present disclosure. In step 705, module 130 detects, on a source code management system 140, a pull request from an upstream version of a software to one or more target versions of the software. In response to this detection, module 130 executes backporting (steps 710-725).

For example, in step 705, module 130 may be responsible for monitoring a source code management system, such as GitHub or GitLab, to identify when a pull request is initiated from the upstream version of a software project. The upstream version typically represents the main or original repository where the primary development occurs. This pull request aims to introduce changes, such as new features or bug fixes, into one or more target versions, which could be branches or forks that have diverged from the upstream. For instance, consider a scenario where a new security patch is developed in the main branch of an open-source project. Module 130 detects this pull request and recognizes that the patch needs to be applied to older versions of the software that are still in use. Upon detection, module 130 triggers a series of actions known as backporting, detailed in steps 710-725. Backporting involves adapting the changes from the pull request to ensure compatibility with the target versions, which may have different dependencies or configurations. This process ensures that critical updates are consistently applied across all relevant versions, maintaining the software's integrity and security.

In step 710, module 130 collects input parameters associated with the pull request from the source code management system. These input parameters include a patch, which is a file detailing the specific changes proposed in the pull request.

Module 130 collects comprehensive information about the upstream version of the software, which may encompass the programming language used, the libraries and frameworks integrated, and any compatibility details like minimum system requirements. For example, if the upstream version is written in Python and utilizes specific libraries like NumPy or Pandas, this information is captured as part of the input parameters. Additionally, module 130 gathers similar parameters for each target version of the software, which might be different branches or forks that require the patch. These parameters help in understanding the differences in dependencies, configurations, or system requirements between the upstream and target versions. For instance, if a target version is an older release that supports a different set of libraries or runs on a different operating system, this information is crucial for ensuring that the patch can be adapted and applied correctly.

Steps 715-725 are then performed for each target version of the software.

In step 715, module 130 analyzes the input parameters using a first machine learning model (MLM) (e.g., determination module 162) to determine whether the target version is affected by the patch. The analysis aims to ascertain whether the target version of the software is impacted by the patch included in the pull request. The machine learning model is trained to evaluate various factors, such as code dependencies, compatibility requirements, and historical data on how similar patches have affected different software versions. For instance, if the patch addresses a security vulnerability in a library used by both the upstream and target versions, the model will assess the likelihood of the target version being susceptible to the same issue. The model might consider the programming language, library versions, and system configurations as part of its analysis. Suppose the upstream version uses a newer version of a library that includes a security fix, while the target version relies on an older, vulnerable version of the same library. In this case, the machine learning model would determine that the target version is indeed affected by the patch, necessitating its application.

Training the first machine learning model used in module 130 may involve various steps to ensure the model can accurately determine the impact of patches on different software versions. Initially, a comprehensive dataset may be compiled, comprised of historical data on past pull requests, patches, and their effects on various software versions. This dataset includes features such as code dependencies, library versions, system configurations, and outcomes of previous patch applications. The model may then be trained using supervised learning techniques, where the model learns to recognize patterns and correlations between these features and the successful or unsuccessful application of patches.

During training, the first machine learning model may be exposed to a labeled dataset, where the outcomes of past patch applications are known, allowing the model to learn from these examples. In some aspects, techniques such as cross-validation and hyperparameter tuning may be employed to optimize the model's performance and prevent overfitting. In some aspects, the first machine learning model may be periodically retrained with new data to adapt to evolving software environments and emerging patterns.

In step 720, module 130 generates, by a second MLM (e.g., AI processing module 163), an adapted patch that adapts the patch to a source code of the target version, wherein the first MLM indicates that the target version is affected by the patch.

For example, AI processing module 163 creates an adapted patch specifically tailored for the target version's source code. This process is initiated when the first machine learning model determines that the target version is indeed impacted by the original patch. The second machine learning model is trained to modify the patch to ensure compatibility with the target version's unique codebase and environment. This involves analyzing the differences between the upstream and target versions, such as variations in code structure, library dependencies, and system configurations. For example, if the target version uses an older library that lacks certain functions present in the upstream version, the AI processing module 163 may adjust the patch to accommodate these discrepancies, possibly by rewriting code segments or substituting alternative functions. The second machine learning model leverages its training on historical patch adaptations and code transformation techniques to perform these modifications accurately. By generating an adapted patch, module 130 ensures that the necessary updates are seamlessly integrated into the target version, maintaining functionality and stability while addressing the identified issues.

In some aspects, training the second machine learning model may involve compiling a diverse dataset containing examples of past patches and their adaptations across various software environments. This dataset includes features such as code differences between upstream and target versions, library dependencies, and the specific modifications made to adapt patches successfully. The second machine learning model may be trained using supervised learning techniques, where the model learns to identify patterns and strategies for modifying patches based on these features. During training, the second machine learning model is exposed to a labeled dataset, where the adaptations and their outcomes are known, allowing it to learn from these examples. In some aspects, the second machine learning model is a LLM that outputs the adapted patch.

Consider a scenario where a security vulnerability is discovered in a web application framework's library function, sanitize_input(), which is used to clean user input to prevent SQL injection attacks. The upstream version of the software may release a patch that updates this function to a more secure version, sanitize_input_v2(), which includes additional checks and balances. The original patch may be:
#Original patch in the upstream version
def sanitize_input_v2(user_input):
   #New security checks
   cleaned_input=perform_additional_checks(user_input) return cleaned_input

The target version of the software, however, uses an older version of the framework that does not support perform_additional_checks(). The second machine learning model analyzes the differences and generates an adapted patch that maintains compatibility with the target version's environment. The adapted patch may be:
#Adapted patch for the target version
def sanitize_input_v2(user_input):
   #Alternative security checks compatible with the older framework
   cleaned_input=alternative_security_checks(user_input)
   return cleaned_input
def alternative_security_checks(user_input):
   #Implement equivalent security measures
   #Compatible with the older framework
      return user_input.replace(“′”, “′′”) #Basic SQL injection prevention

In this example, the adapted patch replaces the unsupported function with alternative_security_checks(), which provides a similar level of security using methods compatible with the older framework. This ensures that the target version remains secure without requiring a complete framework upgrade.

In step 725, module 130 applies the adapted patch on the target version via the source code management system. For example, module 130 may check out the target version's branch or repository to prepare it for the update. Module 130 may then apply the adapted patch, by executing commands that merge the patch into the existing code, resolving any conflicts that arise due to differences between the patch and the current code.

In some aspects, module 130 may further verify that all changes are correctly integrated, maintaining the integrity and functionality of the target version. After applying the patch, module 130 may run a series of automated tests to verify that the patch has been successfully implemented and that the software continues to operate as expected. Based on successful testing, the changes are committed to the source code management system, documenting the update and making the update available for further review or deployment. This comprehensive approach ensures that the adapted patch is seamlessly incorporated into the target version, addressing any identified issues while preserving the software's stability and performance.

FIG. 8 is a block diagram illustrating a computer system 20 on which aspects of systems and methods for backporting software patches may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices. For example, computer system 20 may represent any of user devices 104A, 104B, 104C, server 120A, 120B, and/or 120C.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for automated backporting of patches using machine learning, the method comprising:
detecting, on a source code management system, a pull request from an upstream version of a software to one or more target versions of the software; and
when the pull request is detected, executing backporting by:
collecting input parameters associated with the pull request from the source code management system, wherein the collected input parameters comprise a patch; and
for each target version of the software:
analyzing the input parameters using a first machine learning model (MLM) to determine whether the target version is affected by the patch;
generating, by a second MLM, an adapted patch that adapts the patch to a source code of the target version, wherein the first MLM indicates that the target version is affected by the patch; and
applying the adapted patch on the target version via the source code management system.

2. The method of claim 1, further comprising:
returning, on a user interface, a status indicating that the target version is not affected by the patch when the target version is not affected by the patch.

3. The method of claim 1, further comprising:
storing and/or sending data for updating datasets used for training the first MLM and/or the second MLM, wherein the first MLM and the second MLM are provided by an artificial intelligence (AI)-powered web service.

4. The method of claim 1, further comprising:
testing the adapted patch for errors; and
when the testing of the adapted patch indicates an error in backporting:
updating a number of attempts for adaptation of the patch;
adjusting or re-generating the adapted patch until either the adapted patch is successfully backported, or the number of attempts reaches a predetermined threshold; and
reporting, on a user interface, a failure when the predetermined threshold is reached without successful backporting of the patch.

5. The method of claim 1, wherein the collected input parameters further comprise a source code of the patch received from upstream, and source codes of any number of target versions.

6. The method of claim 1, further comprising initiating the backporting in response to determining that the pull request is associated with a security fix.

7. The method of claim 1, further comprising: applying automated testing and feedback for backporting of the patch by:
receiving a report of a failure of a backporting of the patch;
activating a pull request refinement process for the reported failure of the backporting of the patch;
providing to an AI-powered web service, test results, previous inputs, configuration details for the refinement, and information related to branches and versions that are affected by the refinement; and
performing patch refinement based on the test results and returning an updated patch to the source code management system.

8. The method of claim 1, wherein events that trigger the backporting are customizable to be initiated based on user-defined conditions.

9. The method of claim 1, wherein users selectively configure which branches should receive backports of patches when the pull request is detected.

10. A system for automated backporting of patches using machine learning, comprising:
at least one memory; and
at least one hardware processor coupled with the at least one memory and configured, individually or in combination, to:
detect, on a source code management system, a pull request from an upstream version of a software to one or more target versions of the software; and
when the pull request is detected, execute backporting by:
collecting input parameters associated with the pull request from the source code management system, wherein the collected input parameters comprise a patch; and
for each target version of the software:
analyze the input parameters using a first machine learning model (MLM) to determine whether the target version is affected by the patch;
generate, by a second MLM, an adapted patch that adapts the patch to a source code of the target version, wherein the first MLM indicates that the target version is affected by the patch; and
apply the adapted patch on the target version via the source code management system.

11. The system of claim 10, wherein the at least one hardware processor is further configured to:
return, on a user interface, a status indicating that the target version is not affected by the patch when the target version is not affected by the patch.

12. The system of claim 10, wherein the at least one hardware processor is further configured to:
store and/or send data for updating datasets used for training the first MLM and/or the second MLM, wherein the first MLM and the second MLM are provided by an artificial intelligence (AI)-powered web service.

13. The system of claim 10, wherein the at least one hardware processor is further configured to:
test the adapted patch for errors; and
when the testing of the adapted patch indicates an error in backporting:
update a number of attempts for adaptation of the patch;
adjust or re-generating the adapted patch until either the adapted patch is successfully backported, or the number of attempts reaches a predetermined threshold; and
report, on a user interface, a failure when the predetermined threshold is reached without successful backporting of the patch.

14. The system of claim 10, wherein the collected input parameters further comprise a source code of the patch received from upstream, and source codes of any number of target versions.

15. The system of claim 10, wherein the at least one hardware processor is further configured to initiate the backporting in response to determining that the pull request is associated with a security fix.

16. The system of claim 10, wherein the at least one hardware processor is further configured to apply automated testing and feedback for backporting of the patch by:
receiving a report of a failure of a backporting of the patch;
activating a pull request refinement process for the reported failure of the backporting of the patch;
providing to an AI-powered web service, test results, previous inputs, configuration details for the refinement, and information related to branches and versions that are affected by the refinement; and
performing patch refinement based on the test results and returning an updated patch to the source code management system.

17. The system of claim 10, wherein events that trigger the backporting are customizable to be initiated based on user-defined conditions.

18. The system of claim 10, wherein users selectively configure which branches should receive backports of patches when the pull request is detected.

19. A non-transitory computer readable medium storing thereon computer executable instructions for automated backporting of patches using machine learning, including instructions for:
detecting, on a source code management system, a pull request from an upstream version of a software to one or more target versions of the software; and
when the pull request is detected, executing backporting by:
collecting input parameters associated with the pull request from the source code management system, wherein the collected input parameters comprise a patch; and
for each target version of the software:
analyzing the input parameters using a first MLM to determine whether the target version is affected by the patch;
generating, by a second MLM, an adapted patch that adapts the patch to a source code of the target version, wherein the first MLM indicates that the target version is affected by the patch; and
applying the adapted patch on the target version via the source code management system.
